(19) United States
(12) Patent Application Publication
(10) Pub. No.: US 2022/0160124 A1
(43) Pub. Date: May 26, 2022

(54) SHELVING SYSTEM IMPROVEMENTS

(71) Applicant: JSH CAPITAL PTE. LTD., Singapore (SG)

(72) Inventor: Brian Hollis, (SG)

(21) Appl. No.: 17/600,979

(22) PCT Filed: Apr. 3, 2020
(86) PCT No.: PCT/IB2020/053180

§ 371 Date: Oct. 1, 2021

(30) Foreign Application Priority Data
Apr. 4, 2019 (AU) 2019901159

(51) Int. Cl. A47B 47/00; A47B 57/58; A47B 96/02; A47F 1/12; A47F 5/00

(52) U.S. Cl. CPC A47B 47/0041; A47B 57/58; A47B 96/021; A47F 5/0068; A47F 1/12; A47F 5/005; A47B 96/027

(57) ABSTRACT

A shelf assembly comprising a plurality of shelf modules joined together to provide a product support surface, wherein each shelf module comprises, a pair of substantially parallel, lengthwise extending side edges comprising joining means cooperative with a joining element to join adjacent shelf modules along contiguous side edges thereof, and wherein each joining element is made from a material of higher specific strength than the shelf modules, such that the shelf assembly has sufficient strength and rigidity that it does not need to rest upon a conventional pre-provided shelf.

### PRIORITY DOCUMENTS

The present application claims priority from Australian Provisional Patent Application No. 2019901159 titled “SHELVING SYSTEM IMPROVEMENTS” and filed on 4 Apr. 2019, the content of which is hereby incorporated by reference in its entirety.

### INCORPORATION BY REFERENCE

The following publications are referred to in the present application and their contents are hereby incorporated by reference in their entirety:

International Patent Application No. PCT/AU2009/001699 (WO2010/071943) titled “A SHELVING SYSTEM”.

### TECHNICAL FIELD

The present invention relates to a shelf system or assembly, and each of a shelf module therefor. More particularly, the present invention relates to a gravity fed shelf system of the type used in retail displays where the shelf is sloped so that this is higher at the back than at the front thereof, causing products on the shelf to slide toward or to the forward edge thereof.

### BACKGROUND

Some gravity fed shelf systems utilise a plurality of longitudinally extending partitions which may be installed in selected locations (i.e. which are positionable), so as to create chutes for products of varying widths.

Another type of gravity fed shelf system employs rows of rollers on which product can roll to the front as preceding product is removed.

Some applications (small beverage containers for example) are better serviced by the systems of the first described type, while other applications (larger, heavier items) are better serviced by systems of the second described type. Whichever system a user selects, in some cases they must compromise.

It is against this background and the problems and difficulties associated therewith that the present invention has been developed.

### SUMMARY

According to a first aspect there is provided a shelf assembly comprising a plurality of shelf modules joined together to provide a product support surface, wherein each shelf module comprises, a pair of substantially parallel, lengthwise extending side edges comprising joining means cooperative with a joining element to join adjacent shelf modules along contiguous side edges thereof, and wherein each joining element is made from a material of higher specific strength than the shelf modules, such that the shelf assembly has sufficient strength and rigidity that it does not need to rest upon a conventional pre-provided shelf.

In one form, each joining element is elongate and of substantially the same length as the shelf module.

In one form, each joining element is an extruded metal, a plastic or a composite.

In one form, each joining means is in the form of a lengthwise extending channel adapted to receive the joining element.

In one form, each shelf module further comprises a plurality of lengthwise extending tubes spaced apart transversely across the shelf module, comprising a passageway for receiving a reinforcing element, wherein each reinforcing element is elongate and of substantially the same length as the shelf module.

In one form, each shelf module comprises a first major face and a second major face opposite the first, and wherein the first major face of each shelf module is adapted for engagement with at least one lengthwise extending partition, and the second major face is adapted to accommodate a plurality of transversely extending rollers.

In one form, the first major face is adapted for engagement with a plurality of transversely spaced, lengthwise extending partitions.

In one form, the shelf module comprises an array of lengthwise extending slats spaced apart transversely across the module, and an array of spaced apart, transversely extending ribs extending between these slats along the length of the module.

In one form, the slats sit proud of the ribs on the first major face.

In one form, the first major surface of the shelf module is adapted to engage the at least one partition by way of at least some of the slats comprising flange formations at or near an upper end thereof, each of the flange formations being separated from the flange formation on any adjacent slat.

In one form, the second major face is adapted to nest a plurality of transversely extending rollers arranged into a plurality of lengthwise extending rows.

In one form, the second major face of the shelf module is adapted to nest the plurality of rollers by way of comprising at least a pair of transversely spaced, lengthwise extending walls, between which the transversely extending rollers are nested.

In one form, the second major face of the shelf module comprises a plurality of the lengthwise extending walls transversely spaced across the shelf module so as to define a plurality of rows for the rollers.

In one form, the shelf assembly further comprises at least one partition, where each shelf module is positioned with its first major face upward, with the at least one partition secured thereto.

In one form, the shelf assembly further comprises a plurality of transversely extending rollers, where the shelf module is positioned with its second major face upward, with the rollers nested therein.

In one form, the second major face is further adapted for engagement with at least one lengthwise extending partition.

In one form, the second major face is further adapted for engagement with a plurality of transversely spaced, lengthwise extending partitions.

In one form, the shelf assembly further comprises at least one partition, and a plurality of transversely extending rollers, where each shelf module is positioned with its second major face upward, with the partition secured thereto and the rollers nested therein.

In one form, the shelf assembly further comprises a plurality of roller modules adapted for engagement with the second major face of each shelf module, each roller module adapted to nest a plurality of transversely extending rollers, and configured for engagement with at least one lengthwise extending portion.

### BRIEF DESCRIPTION OF DRAWINGS

Embodiments of the present invention will be discussed with reference to the accompanying drawings wherein:

FIG. 1 is an isometric view of a shelf module according to an embodiment, with its first major face directed upwardly;

FIG. 2 is a detail view of one end of the shelf module of FIG. 1;

FIG. 3 is an exploded view of an assembly of the shelf modules comprising a plurality of the shelf modules of FIG. 1;

FIG. 4 is a detail view of an end of the exploded shelf assembly of FIG. 3;

FIG. 5 is a detail view of an end of the assembled shelf assembly of FIG. 3;

FIG. 6 is an exploded view of a shelf assembly which includes the assembly of shelf modules of FIG. 3;

FIG. 7 is an isometric view of the partially assembled shelf assembly of FIG. 6;

FIG. 8 is a side view of the partially assembled shelf assembly of FIG. 7;

FIG. 9 is an isometric view of the assembled shelf assembly of FIG. 6;

FIG. 10 is an isometric view of a partition from the assembled shelf assembly of FIG. 6;

FIG. 11 is a detail view of an end of the partition of FIG. 10;

FIG. 12 is an end view of the partition of FIG. 10;

FIG. 13 is an exploded view of an assembly of shelf modules comprising the shelf module of FIG. 1, each of which has its first major face directed upwardly;

FIG. 14 is an isometric view of the assembly of shelf modules of FIG. 13;

FIG. 15 is an isometric view of the assembly of FIG. 14, with additional components illustrated in an exploded relationship;

FIG. 16 is an isometric view of the assembly of FIG. 15;

FIG. 17 is a side view of the assembly of FIG. 16;

FIG. 18 is an isometric view of a joining element according to a further embodiment;

FIG. 19 is a detail view of an end of an assembled shelf assembly according to a further embodiment, comprising the joining element of FIG. 18;

FIG. 20 is an isometric view of a joining element according to a further embodiment;

FIG. 21 is an exploded view of a shelf assembly according to a further embodiment, comprising the joining element of FIG. 20;

FIG. 22 is a detail view of the end of the shelf assembly of FIG. 21;

FIG. 23 is a detail view of the end of the shelf assembly of FIGS. 19 through 22, comprising an edge member;

FIG. 24 is a detail view of the end of the shelf assembly comprising the edge member of FIG. 23;

FIG. 25 is an isometric view of the shelf assembly of FIGS. 23 and 24;

FIG. 26 is an end view of the joining element of FIG. 20;

FIGS. 27 and 28 are isometric views of the shelf assembly comprising the joining element of FIGS. 20 and 26;

FIG. 29 is a detail view of an end of an assembled shelf assembly according to a further embodiment;

FIG. 30 is an end view of the shelf assembly of FIG. 29;

FIG. 31 is an isometric view of an end of a joining element from the shelf assembly of FIG. 29;

FIG. 32 is a detail view of a corner of a shelf module from the shelf assembly of FIG. 29;

FIG. 33 is an isometric view of an end of an edge element for the shelf assembly of FIG. 29;

FIG. 34 is a top perspective view of a shelf module according to an alternative embodiment;

FIG. 35 is a bottom perspective view of the shelf module of FIG. 34;

FIG. 36 is a front perspective view of a shelf assembly according to an alternative embodiment;

FIG. 37 is a rear perspective view of a portion of the shelf assembly of FIG. 36;

FIG. 38 is a detail view of a portion of FIG. 37;

FIG. 39 is a detail view of a portion of the shelf assembly of FIG. 35 with the partitions removed;

FIG. 40 is a cross-sectional view of a portion of the shelf assembly of FIG. 35 with the partitions removed;

FIG. 41 is a top perspective view of a roller module according to an embodiment; and

FIG. 42 is a bottom perspective view of the support module of FIG. 41.

In the following description, like reference characters designate like or corresponding parts throughout the figures.

### DESCRIPTION OF EMBODIMENTS

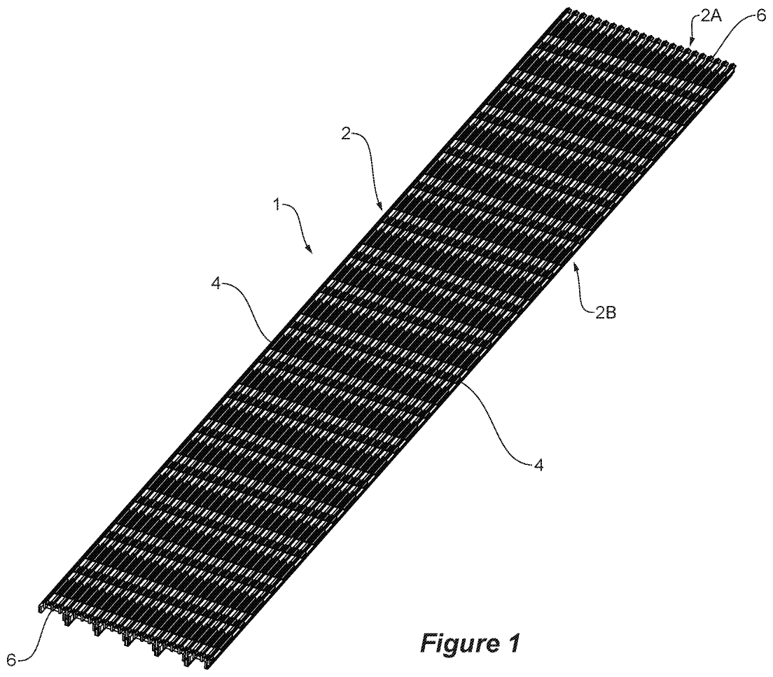

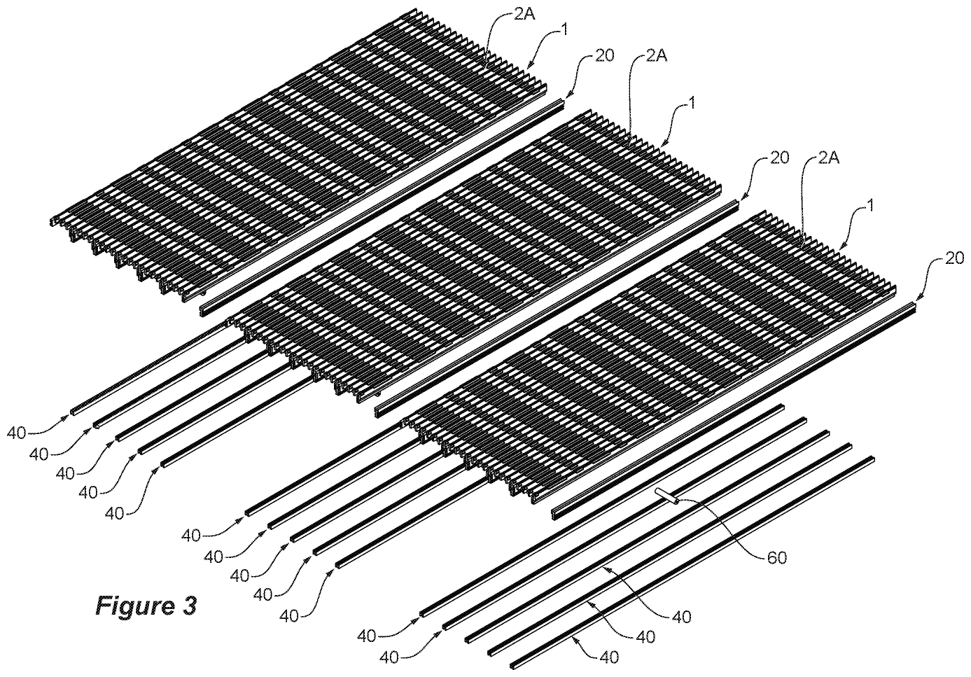

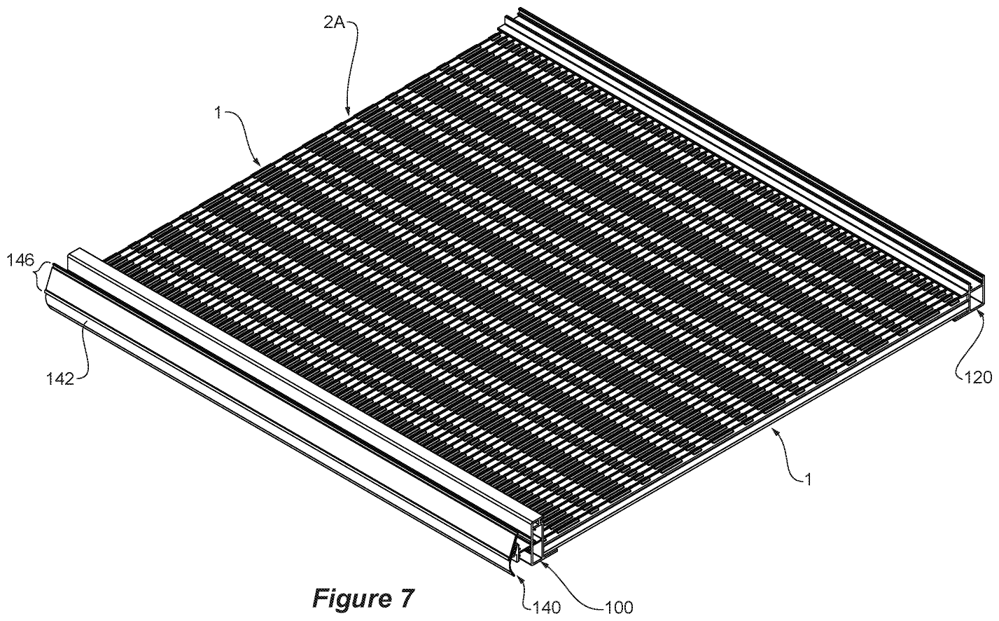

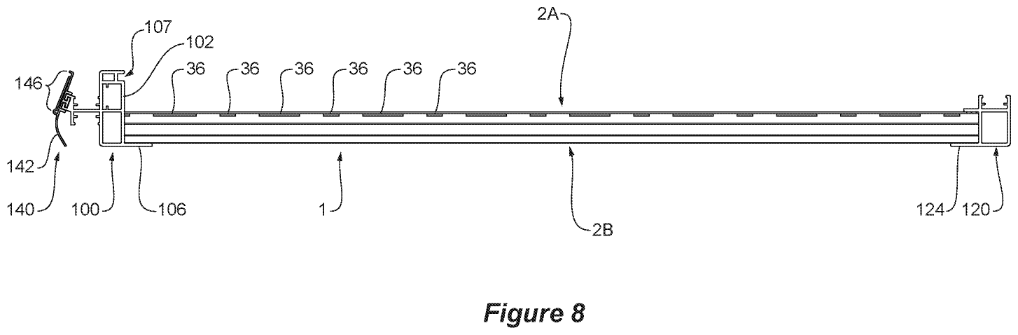

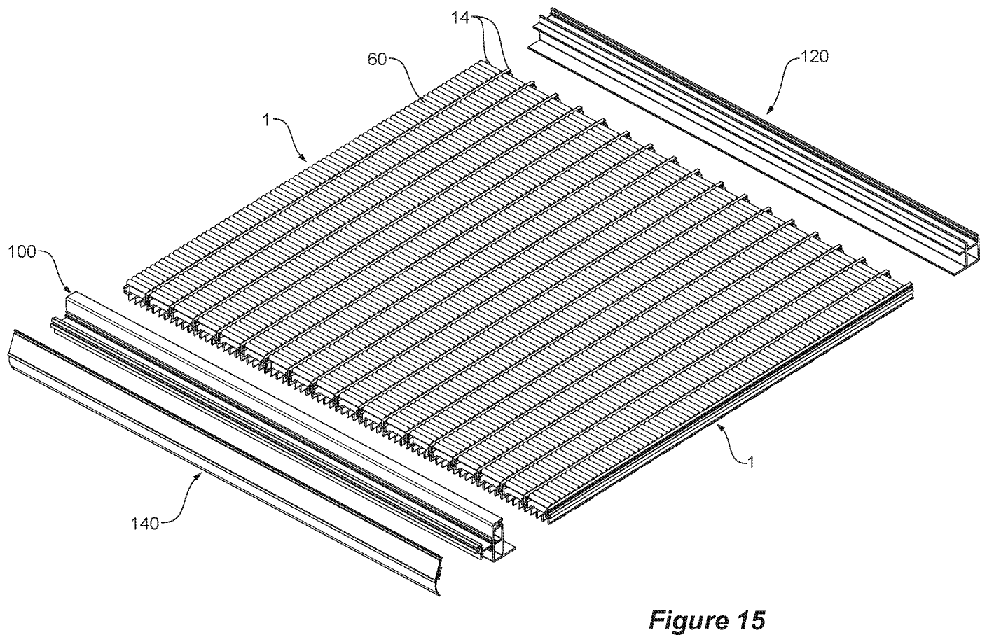

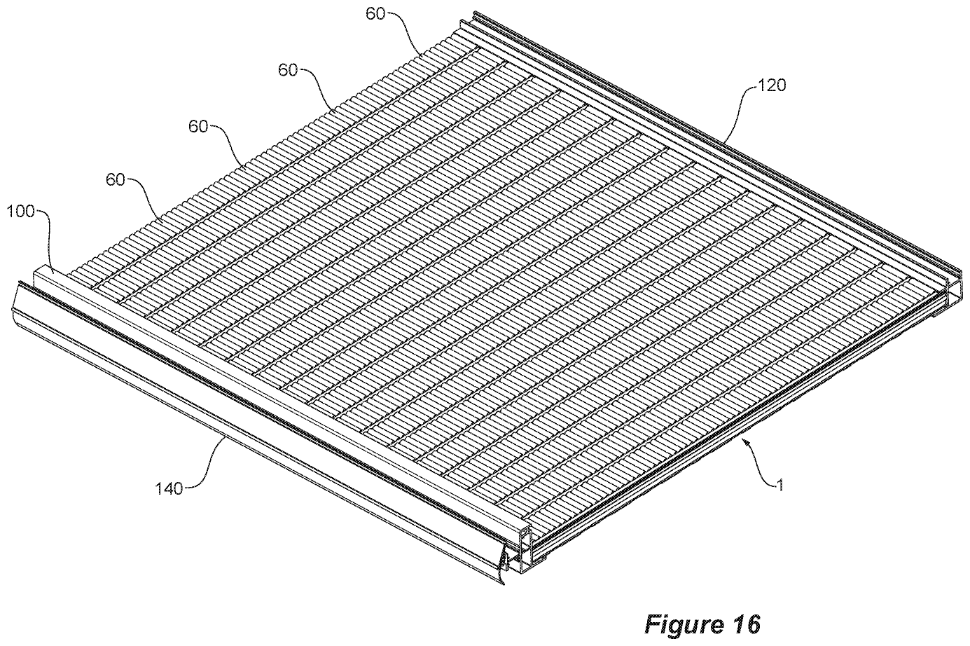

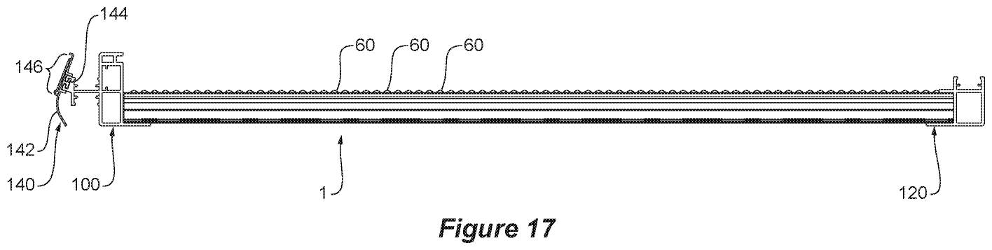

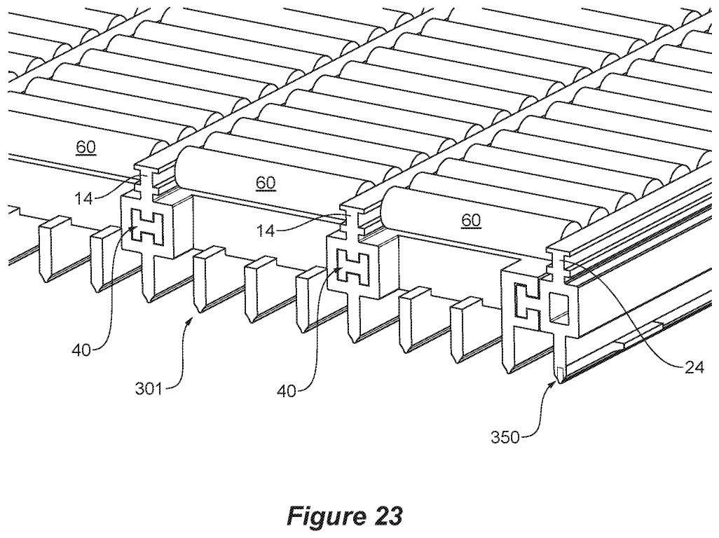

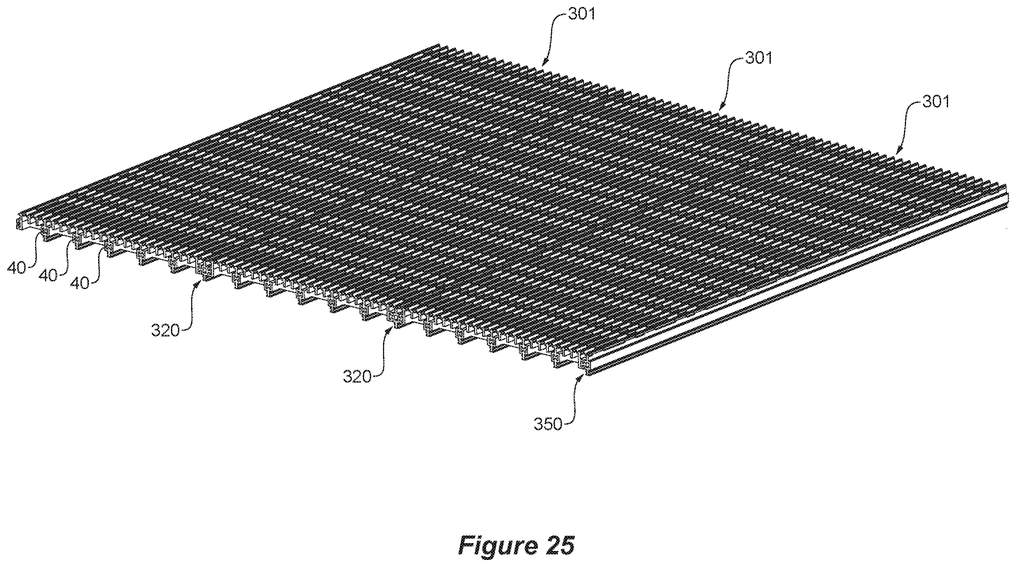

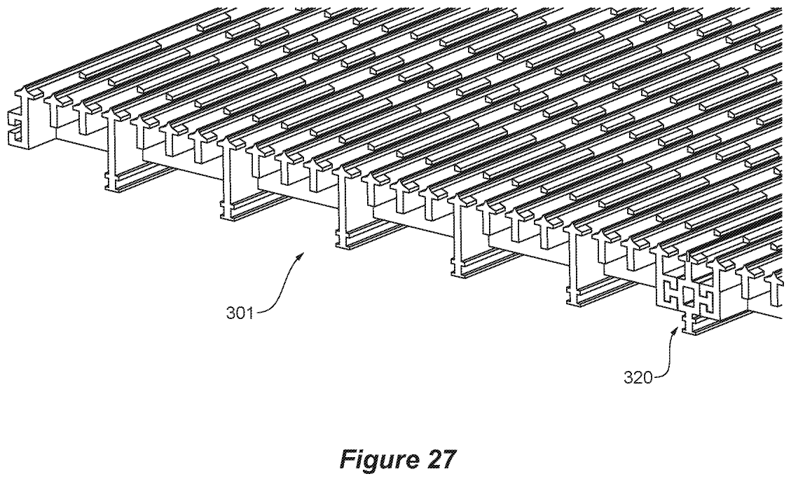

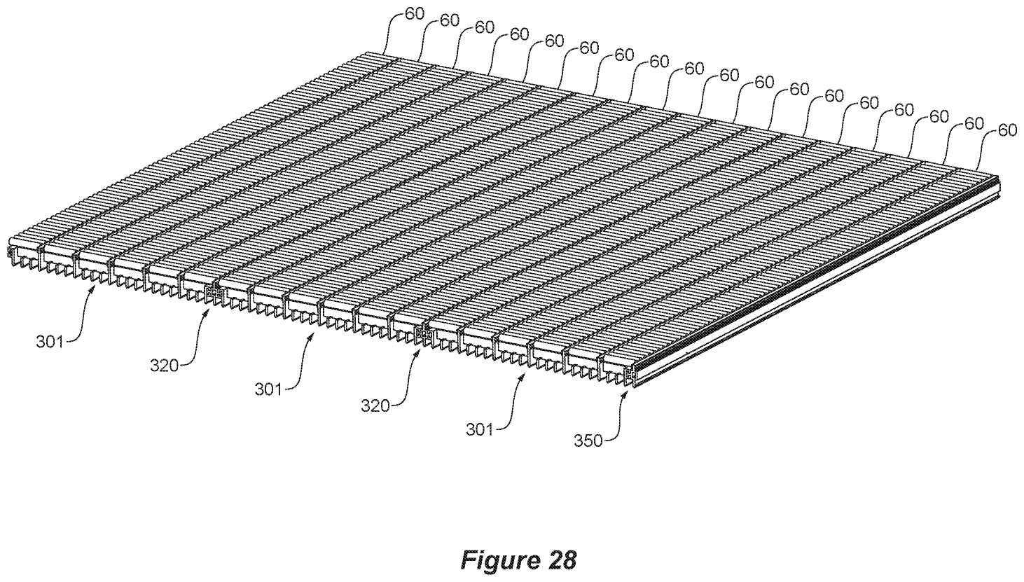

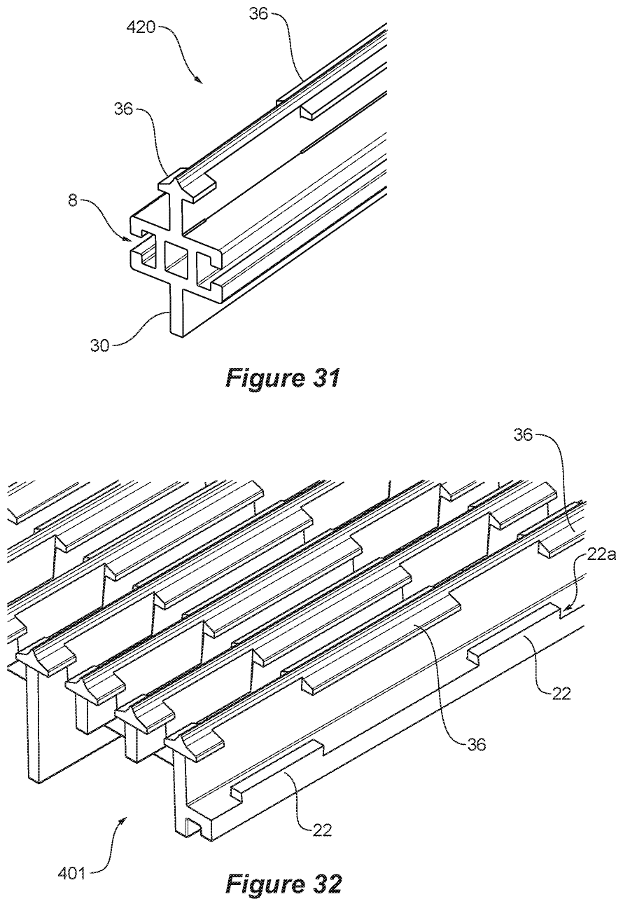

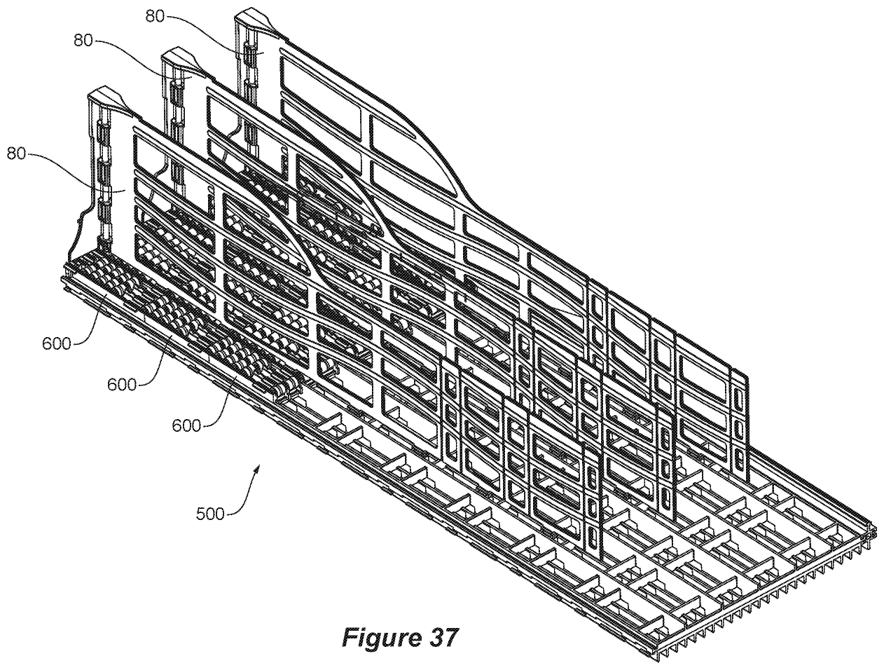

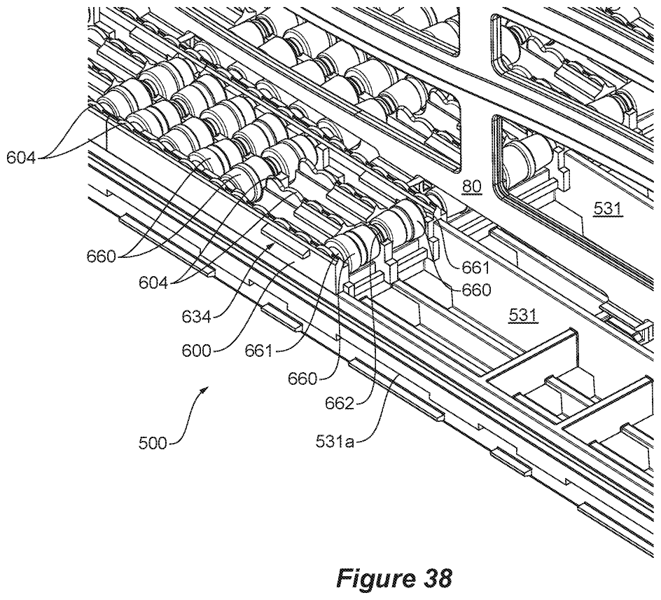

Referring to FIGS. 1 to 42, there is shown a shelf assembly comprising a plurality of shelf modules 1 joined together to provide a product support surface, wherein each shelf module 1 comprises a pair of substantially parallel, lengthwise extending side edges 4 comprising joining means 8 cooperative with a joining element 20 to join adjacent shelf modules 1 along contiguous side edges 4 thereof, and wherein each joining element 20 is made from a material of higher specific strength than the shelf modules 1, such that the shelf assembly has sufficient strength and rigidity that it does not need to rest upon a conventional pre-provided shelf.

Referring now to FIG. 1, there is shown a shelf module 1 according to an embodiment.

The shelf module 1 comprises an elongate body 2 comprising a first major face 2A and a second major face 2B opposite to the first major face 2A, a pair of substantially parallel, lengthwise extending side edges 4 and a pair of substantially parallel, transversely extending end edges 6.

The shelf module has two primary modes of use. The requisite mode of use will determine which of the first major surface 2A or the second major surface 2B is installed facing upward.

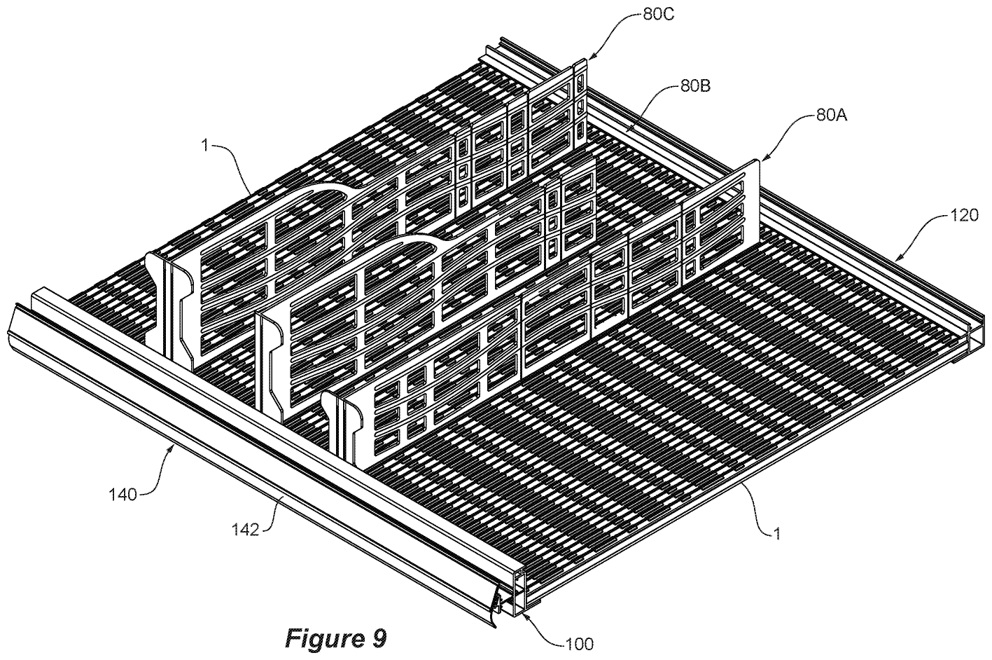

The first major surface 2A of the shelf module 1 is adapted for engagement with a plurality of transversely spaced apart, lengthwise extending partitions or dividers 80, between which chutes for products can be created. Use with these partitions 80 constitutes the first mode of use for the shelf module 1, and this is illustrated in FIG. 9.

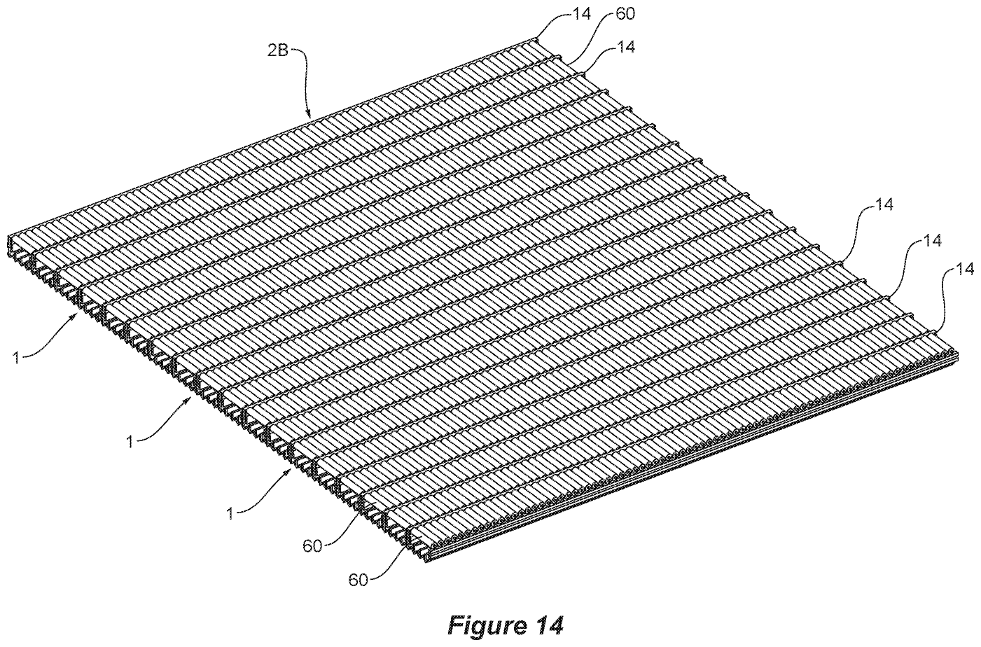

The second major surface 2B of the shelf module 1 is adapted to nest a plurality of transversely extending rollers 60 on which products can roll in a lengthwise direction along the shelf module 1. Use with these rollers 60 constitutes the second mode of use for the shelf module 1, and this is illustrated in FIG. 14.

The shelf module 1 is formed from a plastic material in a mould in a single plastic moulding operation. While it is less desirable, if necessary, the shelf module could be made from two or more moulded parts which are assembled.

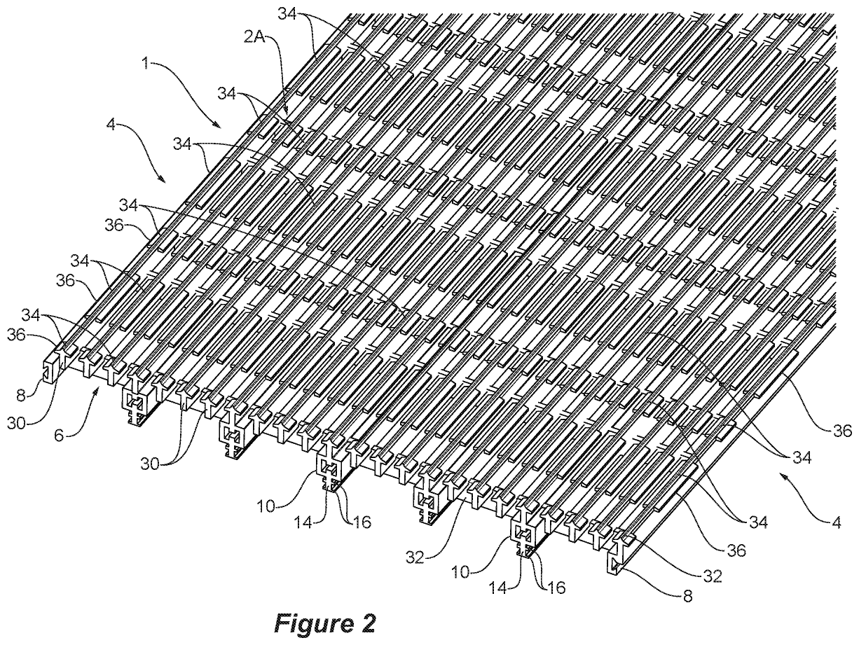

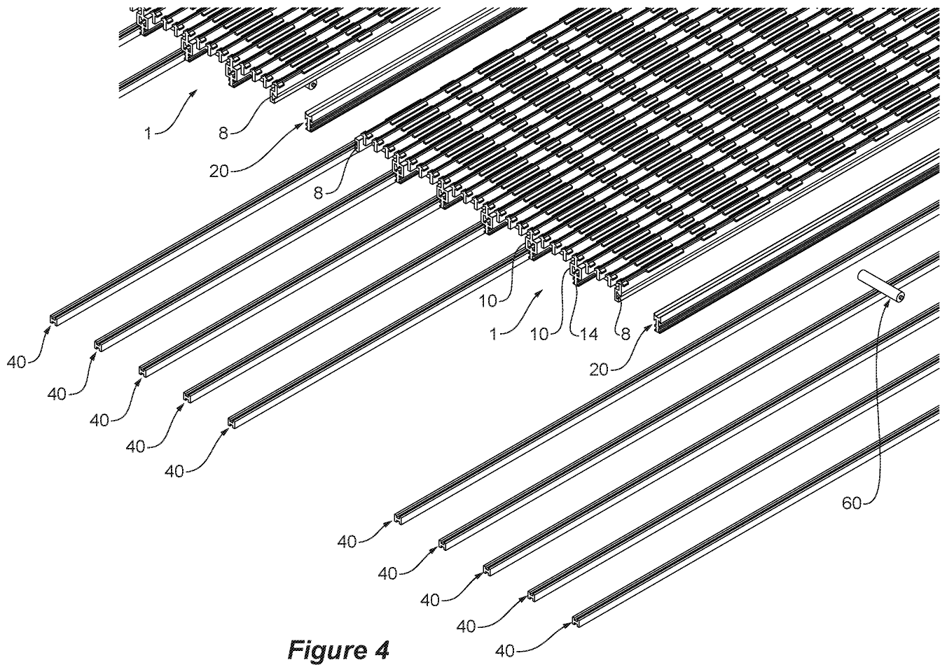

With reference to FIGS. 2 and 4, it can be seen that each of the side edges 4 of the shelf module 1 comprises a means 8 cooperative with a joining element 20 to join a pair of the shelf modules 1 along contiguous side edges 6 thereof to form an assembly of shelf modules 1. In this embodiment, this means comprises a lengthwise extending channel 8 adapted to receive the joining element 20, which is elongate, and of substantially the same length as the shelf module 1.

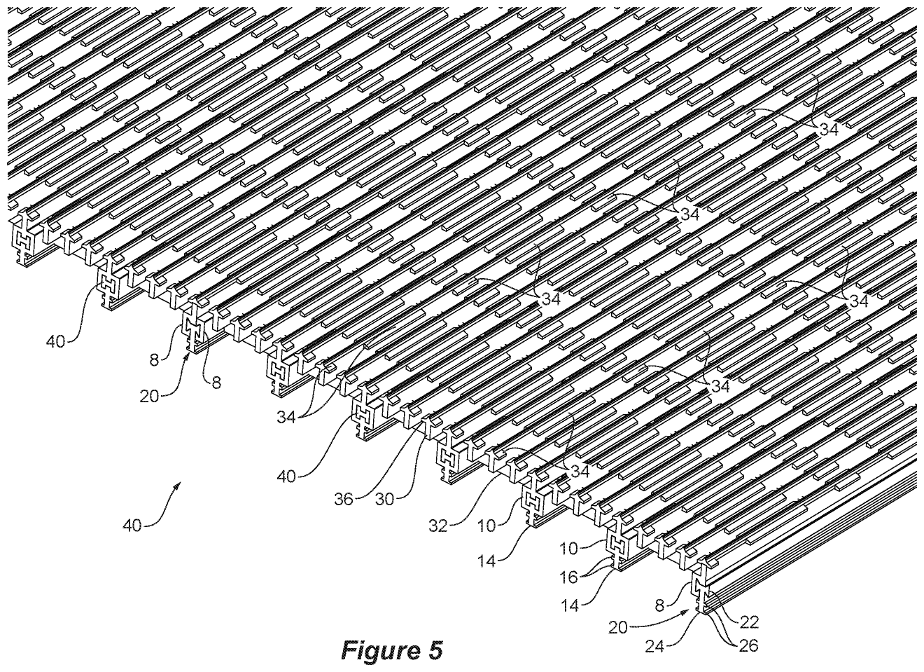

With reference to FIGS. 4 and 5, it can be seen that the joining element 20 comprises a rail sized and shaped for insertion into one of the lengthwise extending channels 8 therefor. For clarity, the joining element 20 will hereinafter be referred to as ‘a joining rail’ 20, and the channel 8 therefor will hereinafter be referred to as ‘a joining channel’ 8.

In one form, the joining rail 20 is made from a material of higher specific strength than is the shelf module 1, this material being an extruded metal in this case, although a strong plastic or composite could be used. In this way, the or each joining rail 20 improves the strength and rigidity of the assembly of shelf modules 1 joined thereby. Being of substantially the same length as the shelf module 1, the joining rail 20 provides this strength and rigidity along the full length of the shelf module 1.

The joining rail 20 comprises a generally T-shaped cross-sectional shape. A head of this T-shaped cross-sectional shape comprises a pair of oppositely directed pins 22, which taper by narrowing inwardly. The joining channel 8 comprises a cross-sectional shape which matches one of these pins 22. In use, each of the pins 22 from one joining rail 20 is received in the joining channel 8 of one of a pair of shelf modules 1 which are being joined thereby.

With reference to FIGS. 2 and 4, it can be seen that the shelf module 1 further comprises a plurality of lengthwise extending tubes 10 spaced apart transversely across the shelf module 1, where each tube 10 comprises a passageway 12 for receiving a reinforcing element 40, which is elongate, and of substantially the same length as the shelf module 1.

With reference to FIGS. 4 and 5, it can be seen that the reinforcing element 40 comprises a rail sized and shaped for insertion into one of the lengthwise extending passageways 12 therefor. For clarity, the reinforcing element 40 will hereinafter be referred to as ‘a reinforcing rail’ 40, and the lengthwise extending passageway 12 will be referred to as a ‘reinforcing rail passageway’ 12.

In one form, the reinforcing rail 40 is made from a material of higher specific strength than is the shelf module 1, this material being an extruded metal in this case, although a strong plastic or composite could be used. Moreover, the reinforcing rail 40 comprises an ‘I-beam’ (or H-beam) cross-sectional shape. In this way, the or each reinforcing rail 40 improves the strength and rigidity of the shelf module 1 with which it is associated.

A lengthwise extending wall 14 extends from each of the lengthwise extending tubes 10 on the second major surface 2B of the shelf element 1. A pair of vertically spaced lips 16 extend outwardly from each side of each of these walls 14. In the second mode of use, a row of transversely extending rollers 60 is inserted between a pair of adjacent walls 14. Each end of each of these rollers 60 is inserted and retained between the lips 16.

Referring now to the joining rail 20 once again, and in particular to a stem 24 of its T-shaped cross-sectional shape. Like the lengthwise extending walls 14, this stem 24 comprises a pair of vertically spaced lips 26 extending outwardly from each side thereof. In this way, the stem 24 can cooperate with one of the walls 14 of the shelf module 1 to retain a row of rollers 60.

With reference to FIGS. 2 and 4, it can be seen that the shelf module 1 further comprises an array of lengthwise extending slats 30 spaced apart transversely across the width of the shelf module 1, and an array of spaced apart, transversely extending ribs 32 extending between these slats 30 along the length of the shelf module 1. When the first major face 2A is directed upward, the slats 30 sit atop of the ribs 32.

Each of the slats 30 comprises a plurality of flange formations 34 spaced apart along the length thereof by flange-less slat portions, and each of the flange formations 34 is located at or near a distal (i.e. upper) edge of its respective slat 30. Each flange formation 34 comprises a pair of flanges 36, where one flange 36 extends from each side of the slat 30. Each of the flange formations 36 is separated (i.e. spaced apart) from the flanges 36 on any adjacent slat 30 by a gap there between.

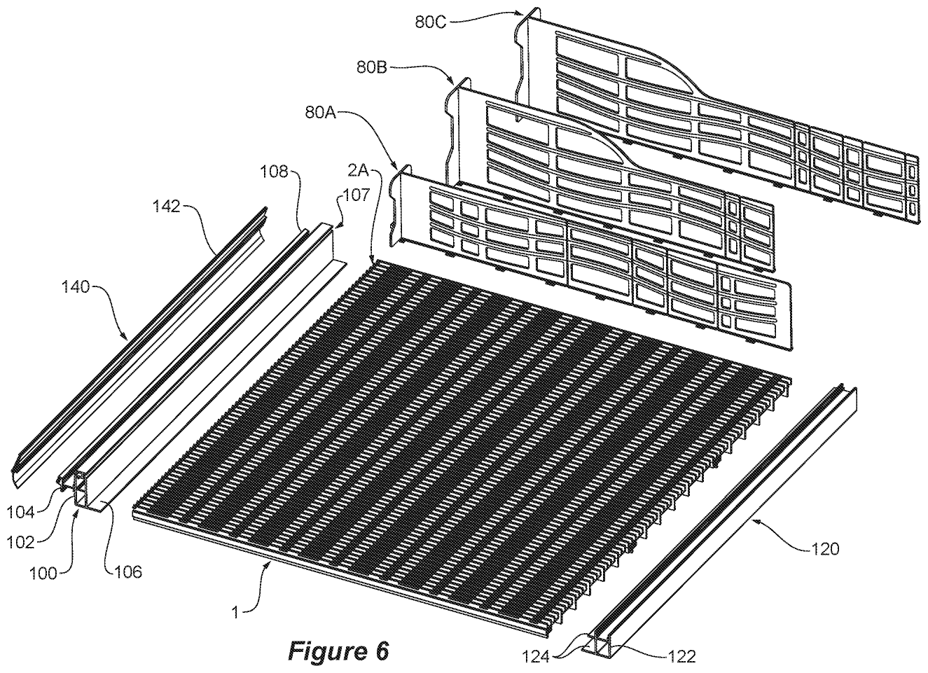

Referring now to FIGS. 6, 9 and 10 through 12, where there are illustrated three embodiments of a moulded plastic partition 80A, 80B and 80C, for use with the shelf module 1. Each partition 80 comprises a wall portion 82 and an integral array of foot portions 84 extending from a lower edge of the wall portion 82, and spaced apart lengthwise along the wall portion by foot-less wall portions. For reasons which will become apparent later, the spacing of these foot portions 84 corresponds with the spacing of flange formations 34 along a slat 30 of the shelf module 1. Each of these foot portions 84 is thicker than the wall portion 82 extending above them.

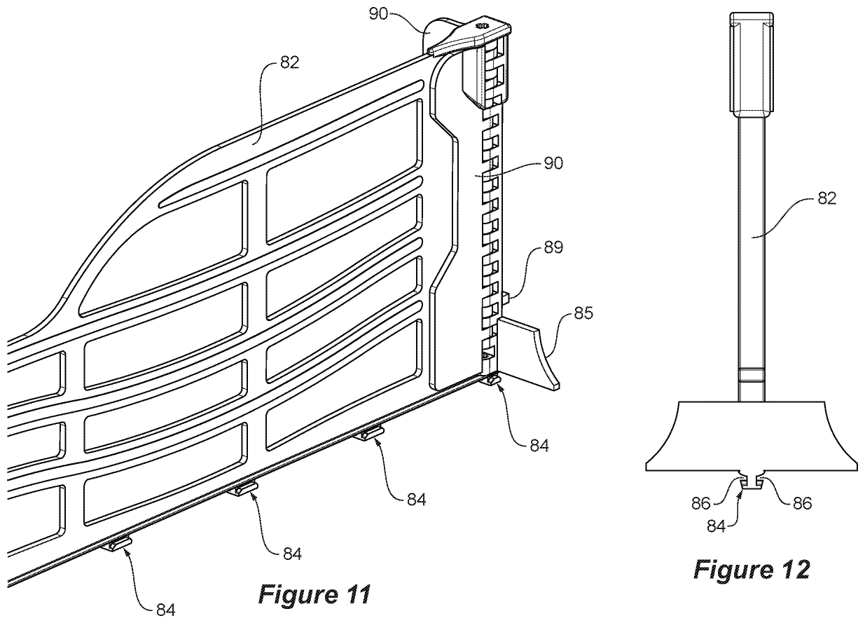

As best shown in FIG. 12, each foot portion 84 of each partition 80 comprises a pair of opposing slots 86 formed therein, which are sized and adapted to receive an outer tip of one of the flanges 36 therein.

Each of the wall portions 82 further comprises a breakaway back section 82A and an interconnected series of breakaway intermediate sections 82B connecting a front section 82C and the back section 82A. The breakaway feature is typically implemented by providing a line of weakness shown at YY, which extends through the partition transverse to its direction of elongation. Breaking away one or more of these breakaway sections 82A or 82B allows the length of the partition 80 to be adjusted to suit.

One end of each partition 80 comprises an end wall 88 extending transversely therefrom so that this end may serve as a front edge of the partition 80. In use then, stock placed in a chute defined between a pair of spaced apart partitions 80, will slide down the chute until it comes to rest against the end walls 88 of the spaced apart partitions 80.

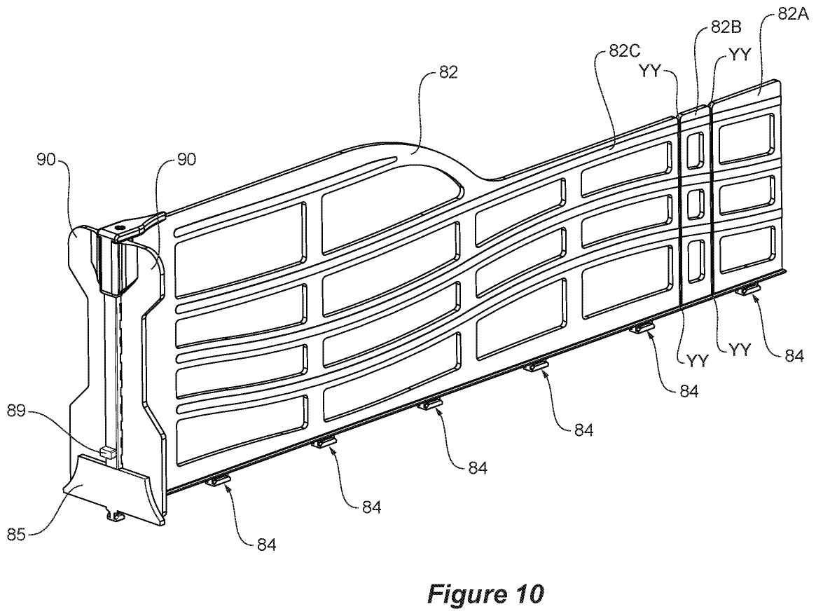

With reference to FIG. 10, it can be seen that the front edge of the partition 80 further comprises a dwarf wall 85 extending transversely to either side of the wall portion 82, and a locating tab 89 projecting from a forward edge of the wall portion 82. In use, when the partition 80 is secured to a shelf module 1, the dwarf wall 85 will extend atop of a plurality of slats 30, thereby providing lateral stability for the partition 80.

In the case of partition 80B, each end wall comprises a pair of wings 90, each of which can be moved between extended and retracted positions relative to the wall portion 82. In the retracted position, a wing 90 lies against the wall portion 82, and when it is extended it extends out from the wall portion 82. In this embodiment, each wing 90 hinges from the wall portion 82.

Referring now to FIGS. 6 through 9, where there is further illustrated a front end rail 100 for use with an assembly of shelf modules 1. As its name suggests, in use, the front end rail 100 will extend along a forward (or consumer facing) edge of the assembly of shelf modules 1.

The front end rail 100 comprises an elongate metal rail of substantially constant cross-sectional shape. This cross-section shape comprises a rectangular hollow section 102, a lengthwise extending forward ledge 104 projecting from a first side of the rectangular hollow section, a lengthwise extending rearward ledge 106 projecting from a second side of the rectangular hollow section 102, and a rearward facing slot 107 for receiving the locating tab 89 of the partition 80. A forward opening lengthwise extending channel section 108 projects from the forward ledge 104.

FIGS. 6 through 9 further illustrate a rear end rail 120 for use with an assembly of shelf modules. As its name suggests, in use, the rear end rail 120 will extend along a rear (away from consumers) edge of the assembly of shelf modules 1.

The rear end rail 120 comprises an elongate metal rail of substantially constant cross-sectional shape. This cross-section shape comprises a square hollow section 122, and a pair of vertically spaced, lengthwise extending forward ledges 124 projecting from a first side of the square hollow section 122.

FIGS. 6 through 9 further illustrate a display strip 140 for use with the front end rail 100.

The display strip 140 comprises an elongate strip of substantially constant cross-sectional shape. This cross-section shape comprises a curved body 142 comprising a convex forward side and a concave rear side from which there projects a lengthwise extending joining portion 144. This joining portion 144 comprises a cross-sectional shape which is sized and shaped (T-shaped in this case) for sliding into the lengthwise extending channel section 108 of the front end rail 100.

The convex forward side of the display strip 140 comprises a forward opening lengthwise extending channel section 146 for receiving point of sale information, such as product and pricing information.

Referring now to FIGS. 6 through 9, in cases where the shelf module 1 is to be used in its first mode, with partitions 80, the first major surface 2A of the or each shelf module 1 is turned facing upwards.

As many shelf modules 1 as are required to form a shelf of the desired width are then joined along contiguous side edges 4 thereof using the joining rails 20 inserted in joining channels 8. A shelf assembly formed in this fashion can be reinforced as required by the use of reinforcing rails 40 inserted into selected (or all) tubes 10.

The assembly of shelf modules 1 is supported along its front and rear edges by the front end rail 100 and rear end rail 120 respectively, all of the foregoing forming a shelf assembly. More specifically, a front edge of each shelf module 1 is supported on ledge 106, and the rear edge of each shelf module 1 is located between the ledges 124, and supported on the lower of these ledges 124.

This shelf assembly is supported at its edges by a plurality of shelf supports (not illustrated), each of which depends from a support column (not illustrated). The shelf assembly has sufficient strength and rigidity that it does not rest upon a conventional pre-provided shelf like system of the prior art.

A plurality of the partitions 80 can be secured to the assembly of shelf modules 1 so that they define a plurality of chutes between them. Products can be positioned in these chutes, and these products will slide toward the front edge of the assembly of shelf modules 1 if this is tilted in this direction.

The display strip 140 can then be secured to the front end rail 100 and product and pricing information inserted in the opening lengthwise extending channel section 146 of the display strip 140.

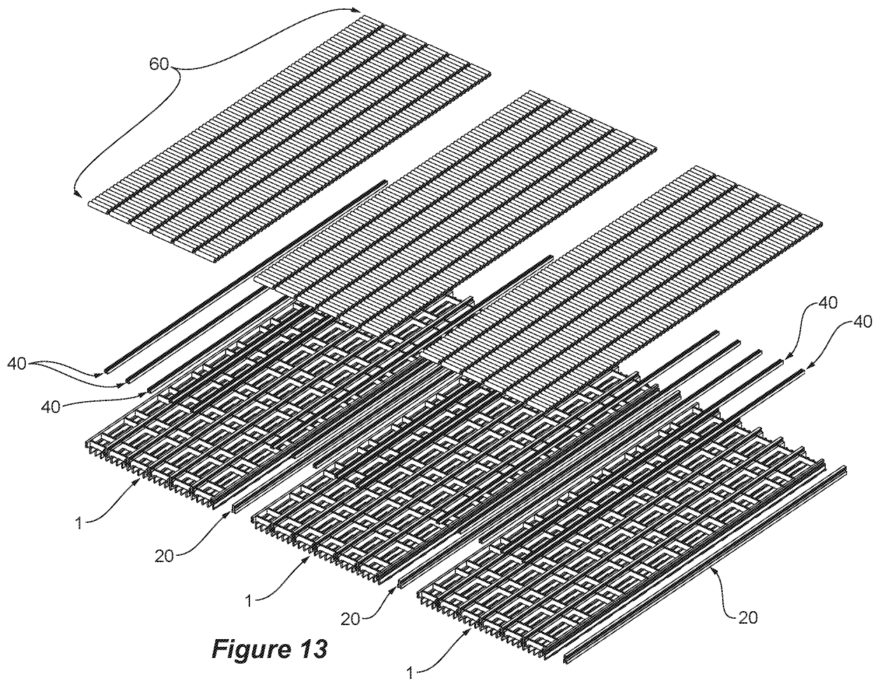

Referring now to FIGS. 13 through 16, in cases where the shelf module 1 is to be used in its second mode, with rollers 60, the second major surface 2B of the or each shelf module 1 is turned facing upwards.

As many shelf modules 1 as are required to form a shelf of the desired width are then joined along contiguous side edges thereof using the joining rails 20 inserted in joining channels 8. A shelf assembly formed in this fashion can be reinforced as required by the use of reinforcing rails 40 inserted into selected (or all) of the tubes 10.

The assembly of shelf modules 1 is positioned in a refrigerator (not illustrated) and supported along its front and rear edges by the front end rail 100 and rear end rail 120 respectively, all of the foregoing forming a shelf assembly. More specifically, a front edge of each shelf module 1 is supported on ledge 106, and the rear edge of each shelf module 1 is located between the ledges 124, and supported on the lower of these ledges 124.

This shelf assembly is supported at its edges by a plurality of shelf supports, each of which depends from a support column. The shelf assembly comprises sufficient strength and rigidity that it does not rest upon a conventional pre-provided shelf like system of the prior art.

Rows of the rollers 60 can then be inserted between pairs of adjacent walls 14. Each end of each of these rollers 60 is inserted and retained between the lips 16. Products can be placed on these rollers 60, and these products will roll on these rollers toward the front edge of the assembly of shelf modules 1 if this is tilted in this direction.

The display strip 140 can then be secured to the front end rail 100 and product and pricing information inserted in the opening lengthwise extending channel section 146 of the display strip 140.

The joining rails 20, reinforcing rails 40, front end rail 100 and rear end rail 120 all contribute to improving the strength and rigidity of a shelf assembly formed from a plurality of the shelf modules 1. When used in combination, these elements help to create a shelf assembly which can handle heavy products, which can extend over large spans, and which does not rest upon a conventional pre-provided shelf like system of the prior art.

Most significantly, the shelf module 1 and shelf system described herein have two modes of use, where previous systems were specifically designed for one or the other of these modes.

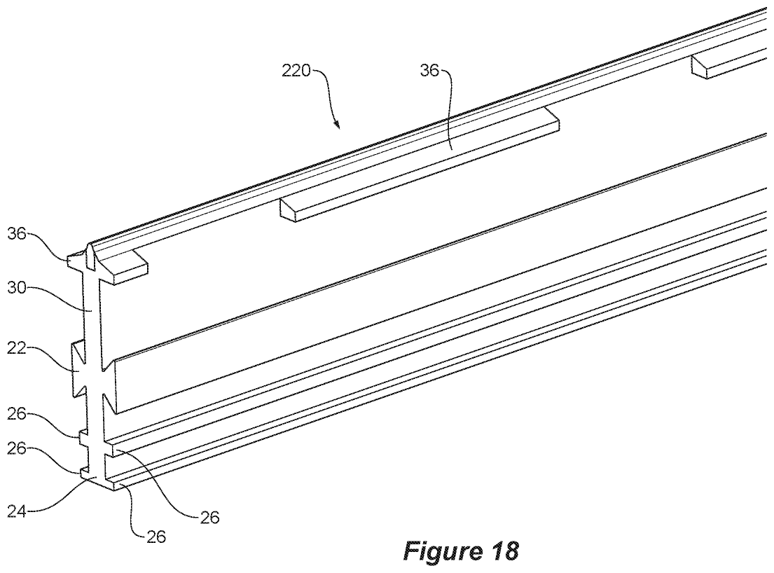

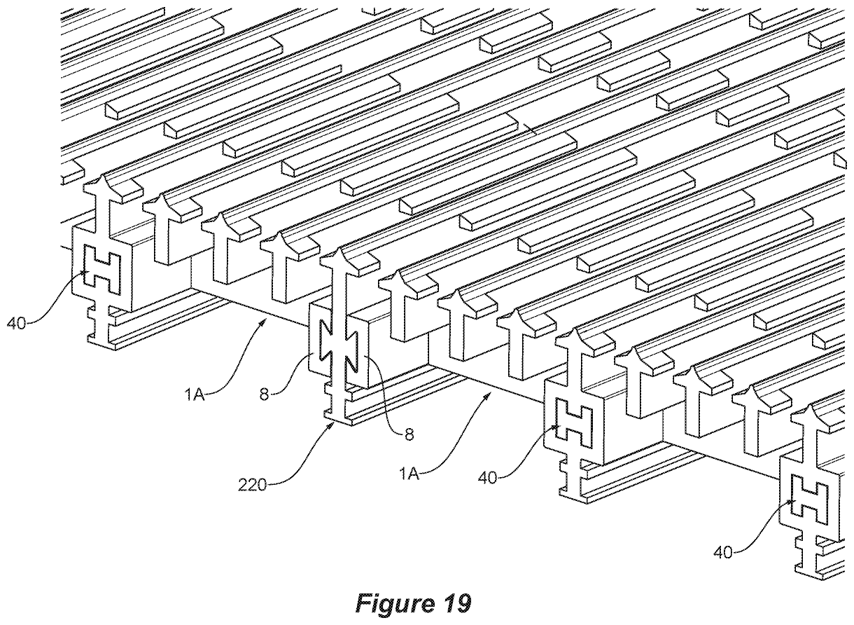

Referring now to FIGS. 18 and 19, where there is illustrated a shelf assembly according to a further embodiment. Those parts of the shelf assembly which are identical (or near-identical) to corresponding parts shown in the shelf assembly of FIGS. 1 through 17, will be denoted by the same reference numerals and will not be described again in detail.

This shelf assembly comprises a joining element 220, which is similar to the joining element 20 of FIGS. 1 through 17, but which differs in that joining element 220 further comprises one of the lengthwise extending slats 30 replete with flanges 36, which was previously associated with shelf module 1. Accordingly, shelf module 1A differs from shelf module 1 in that it need only comprise lengthwise extending channels 8 along side edges 4 thereof, and not a lengthwise extending slat 30 replete with flanges 36. This simplifies moulding of shelf module 1A.

As was the case with joining element 20, the joining element 220 comprises a rail which, preferably, is integrally formed, so in this case the lengthwise extending slat 30 replete with flanges 36 is integrally formed with a remainder of the joining element 220.

With reference to FIG. 19, it can be seen how in use, the joining element 220 (hereinafter ‘joining rail 220’) joins a pair of shelf modules 1A by way of its engagement with the adjacent joining channels 8 of the shelf modules 1 which are being joined thereby. In doing so, joining rail 220 provides the lengthwise extending slat 30 replete with flanges 36 at the interface of the shelf modules 1A.

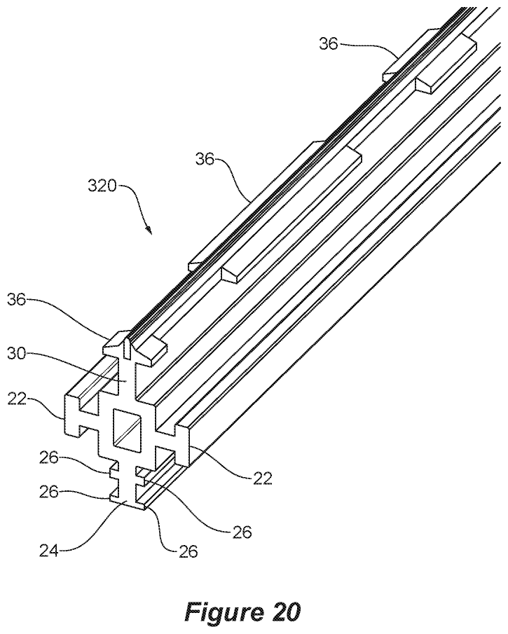

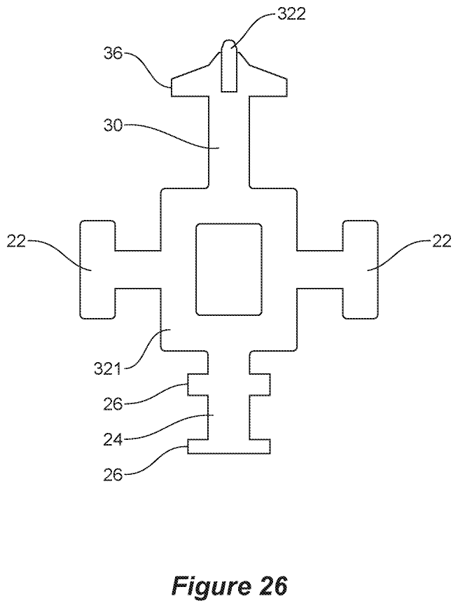

Referring now to FIGS. 20 and 26, where there is illustrated a joining element 320 according to a further embodiment. Those parts of the joining element 320 which are identical (or near-identical) to corresponding parts shown in the joining element 220 of FIGS. 18 and 19, will be denoted by the same reference numerals and will not be described again in detail.

The joining element 320 differs from joining element 220 primarily in that the pair of oppositely directed pins 22 are T-shaped, and the element 320 further comprises a lengthwise extending, centrally positioned tube 321 of rectilinear, hollow cross-sectional shape, which provides additional strength and stiffness.

In the illustrated embodiment, the joining element 320 is extruded from a metal such as aluminium, but incorporates a wear strip 322 of plastic material nested in a lengthwise extending slot.

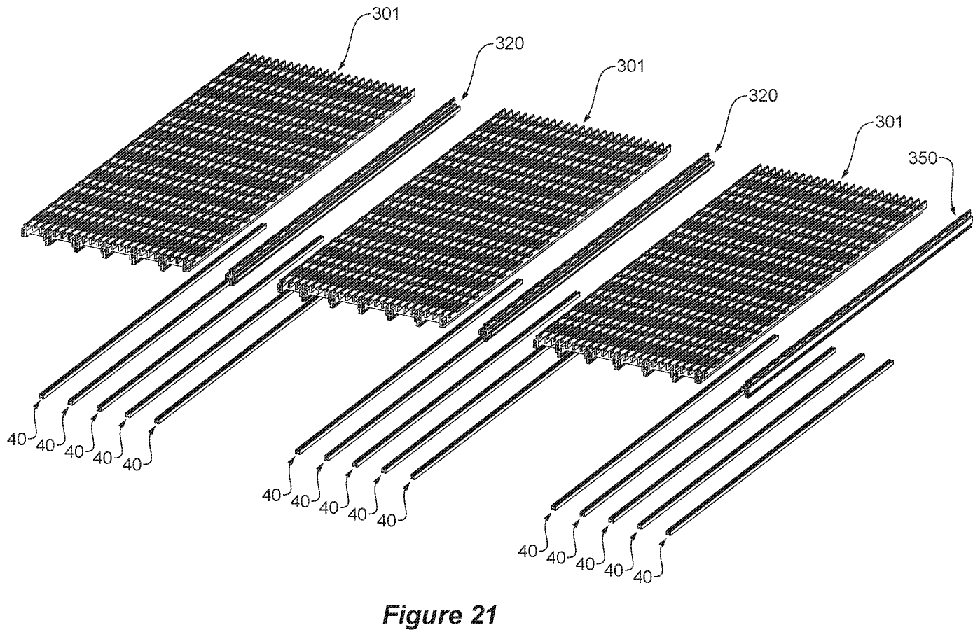

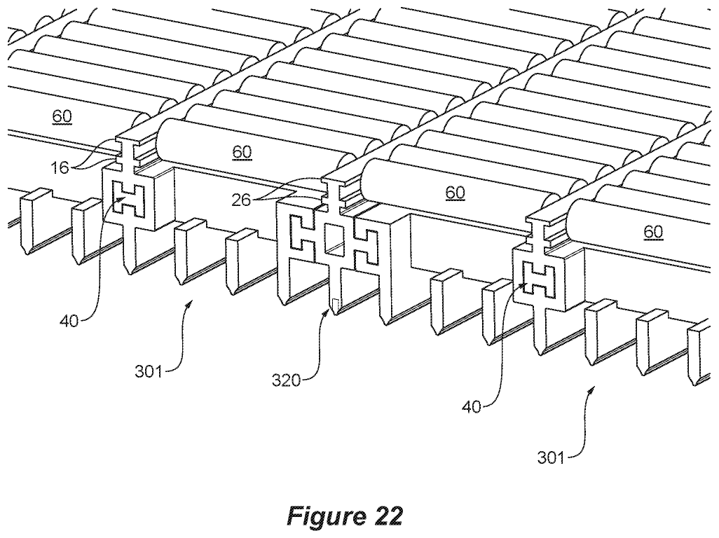

With reference to FIGS. 21 and 22, it can be seen that the shelf module 301 for use with the joining element 320 comprises lengthwise extending channels 8 along side edges 4 thereof, which themselves comprise a cross-sectional shape which is sized and shaped (generally C-shaped in this case) to receive the heads of the T-shaped pins 22.

Referring now to FIG. 21, which, in addition to shelf modules 301, reinforcing rails 40, and joining elements 320, illustrates an exploded assembly comprising an edge element 350. Edge element 350 shares a high degree of structural similarity with joining element 320, but differs in that edge element 350 comprises only one pin 22 (not a pair of oppositely directed, T-shaped pins 22). On the opposite side to pin 22, the tube 321 of the edge element 350 presents a smooth surface. In use, the edge element can be employed at a terminating side edge of a shelf assembly, where no further shelf modules 301 need to be joined, to provide strength and stiffness to the shelf assembly.

Referring now to FIGS. 22, 23 and 28, where the shelf assembly of FIG. 21 is illustrated in the second mode of use, wherein the second major surface 2B of the or each shelf module 1 is turned facing upwards, and rollers 60 are inserted between pairs of adjacent walls 14 and 24, with opposing ends of each of these rollers 60 inserted and retained between the lips 16 and 26, in the above-described manner.

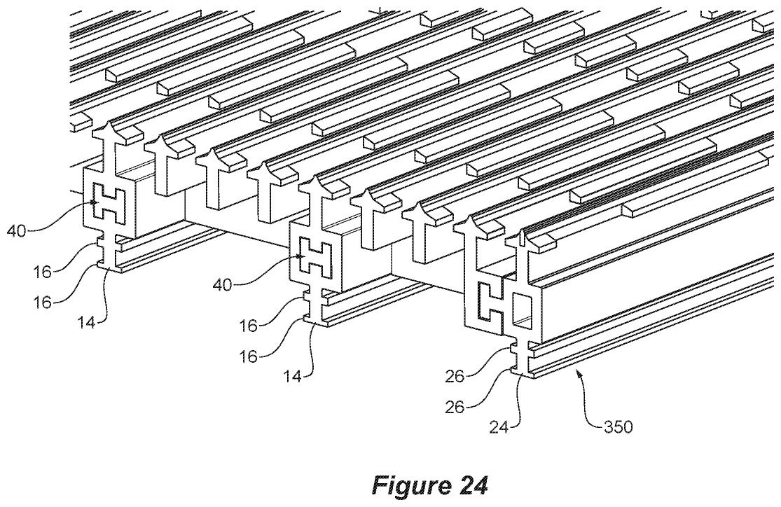

Referring now to FIGS. 24, 25 and 27, where the shelf assembly of FIG. 21 is illustrated in the first mode of use, wherein the first major surface 2A of the or each shelf module 1 is turned facing upwards, for engagement with a plurality of the partitions 80 secured thereto in the above-described manner, so that they define a plurality of chutes between them.

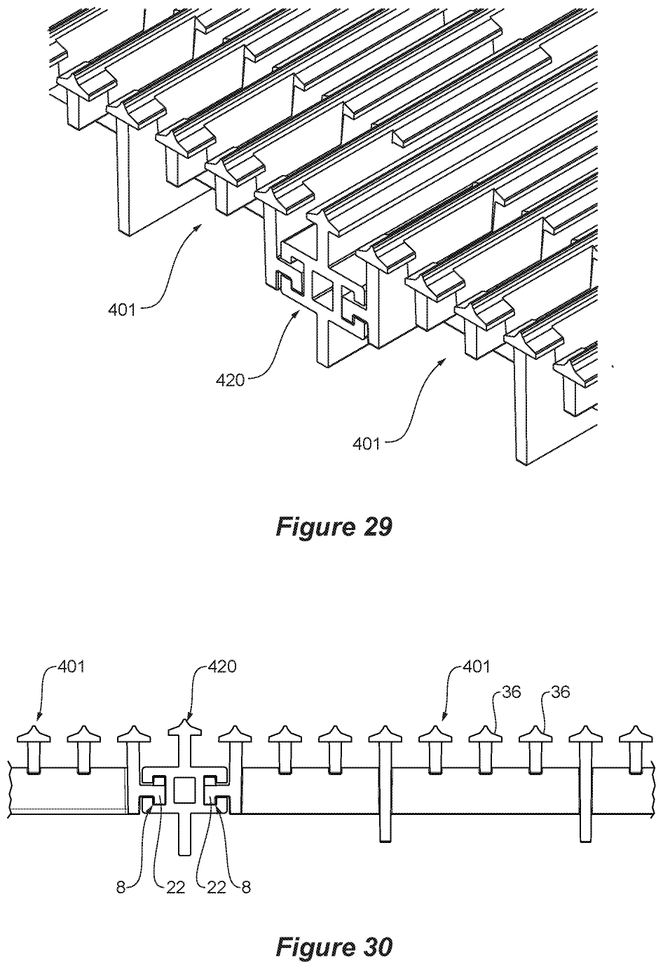

Referring now to FIGS. 29 through 33, where there is illustrated a shelf assembly according to a further embodiment. Those parts of this shelf assembly which are identical (or near-identical) to corresponding parts shown in the shelf assembly of FIGS. 20 through 28 (the previous illustrated embodiment) will be denoted by the same reference numerals and will not be described again in detail.

This shelf assembly comprises a shelf module 401 which is similar to shelf module 301 of the previous illustrated embodiment, and a joining element 420 which is similar to joining element 320.

Shelf module 401 and joining element 420 differ from shelf module 301 and joining element 320 primarily in that the cooperative engaging portions of shelf module 401 and joining element 420 are arranged in a reverse order to those on shelf module 301 and joining element 320.

That is to say, the joining element 420 now comprises a pair of oppositely directed joining channels 8, and the shelf module 401 now comprises a T-shaped pin 22 extending lengthwise along an edge thereof, which is sized and shaped to be slidably received in one of the channels 8 of the joining element 420. Joining element 420 also does away with the separate plastic wear strip 322 of joining element 320, and is entirely made of metal, being most likely an integral aluminium extrusion.

With reference to FIG. 32, it can be seen that an upwardly directed portion of a head of each of these T-shaped pins 22 is divided lengthwise there along by spaces 22a therein, where these spaces coincide with positioning of flanges 36. This arrangement further simplifies molding of the shelf module 420, by facilitating ease of release from an injection molding tool.

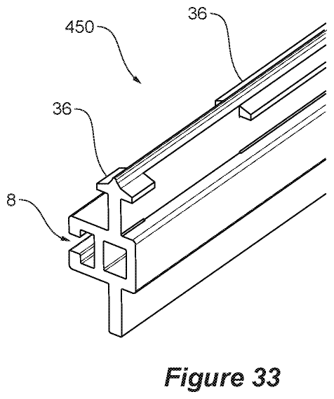

With reference to FIG. 33, there is illustrated an edge element 450 similar to the edge element 350 of the previous illustrated embodiment. Similar to joining element 420, edge element 450 comprises a joining channel 8 in place of the T-shaped pin 22 of edge element 350.

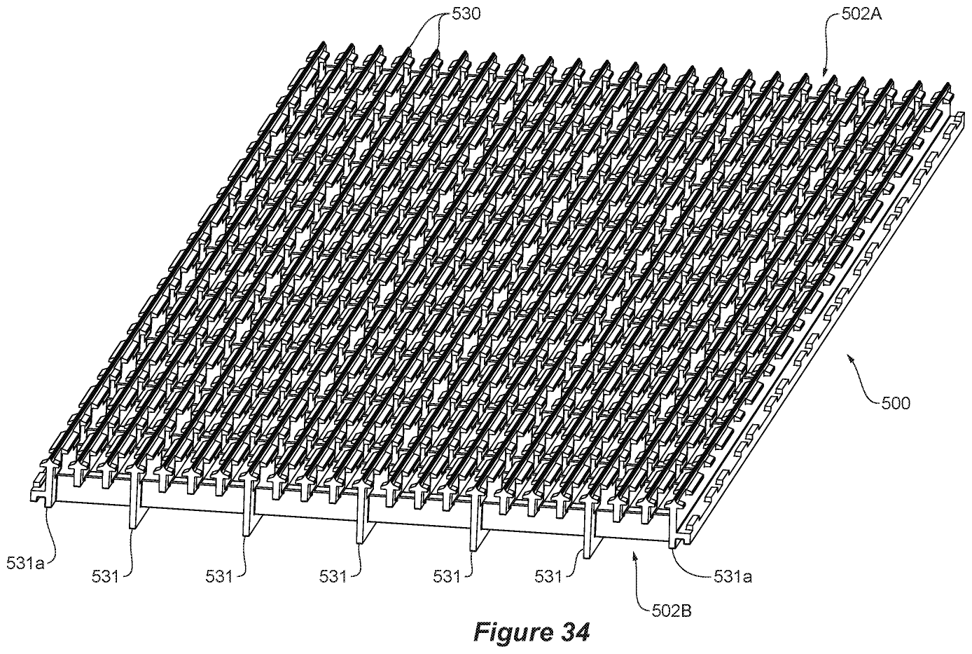

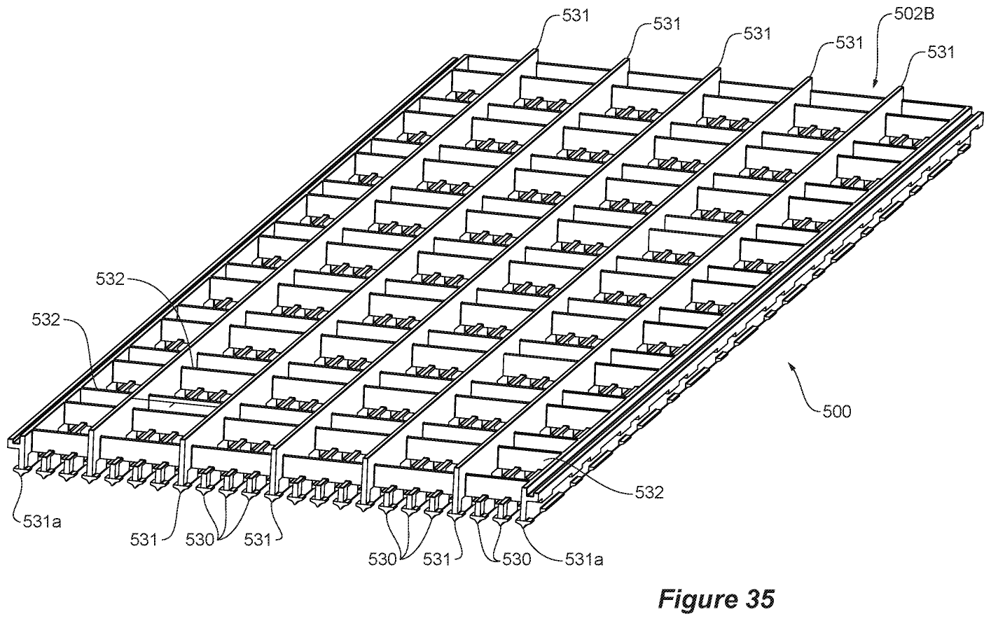

Referring now to FIGS. 34 and 35 where there is illustrated a shelf module 500 according to yet a further embodiment. Similarly to previous embodiments, the shelf module 500 comprises an array of lengthwise extending slats 530 spaced apart transversely across the width of the shelf module, and an array of spaced apart, transversely extending ribs 532 extending along the length of the shelf module. When the first major face 502A is directed upward, the slats 530 sit atop of the ribs 532. When the second major face 502B is directed upward, the ribs 532 sit atop the slats 530, however it can be seen that every fourth slat is an extended slat 531 that extends through and past the ribs 532.

Similarly to previous embodiments, the first major surface 502A of the shelf module 500 is adapted for engagement with a plurality of transversely spaced apart, lengthwise extending partitions 80 between which chutes for products can be created. Use with these partitions constitutes the first mode of use for the shelf module 500.

The second major surface 502B of the shelf module 500 is adapted for engagement with a plurality of roller modules 600. As best shown in FIG. 40, each roller module 600 comprises a plurality of engaging tabs 601 configured to engage with the ribs 532 of the shelf module 500.

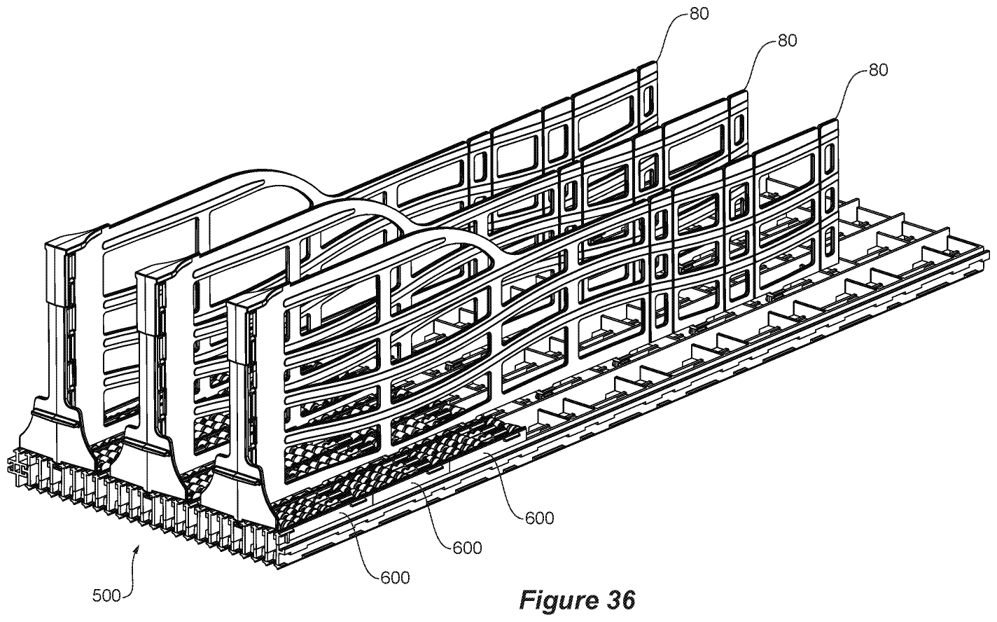

Each roller module 600 is adapted for engagement with the same lengthwise extending partitions 80 previously described as well as being adapted to support a plurality of transversely extending rollers 660 on which products can slide in a lengthwise direction within the chutes provided between the partitions 80, as illustrated in FIGS. 36 to 40.

In the case of the first major surface 502A, it is intended to be used with products of relatively high mass such as 1 litre plastic drink containers that will readily slide on an inclined surface. However, lighter weight products and/or products packaged in cardboard boxes, may not have sufficient weight or may have too large a contact area to move independently on the slats 30. In this case, as with the embodiments shown in both FIGS. 13 to 16 and 34 to 42, the use of rollers allow lighter weight products to move within each individual product chute between partitions.

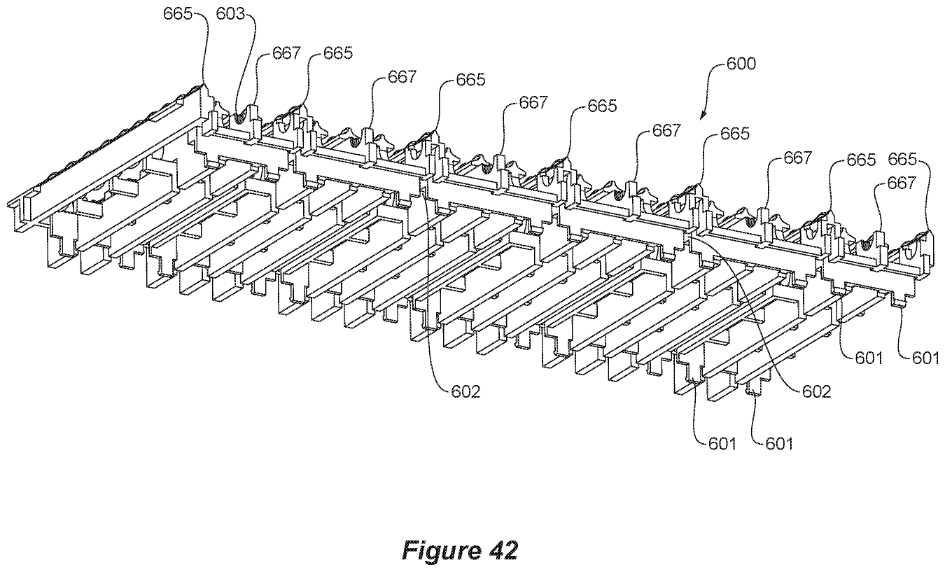

The embodiments shown in FIGS. 34 and 42 are designed so that no one roller in a chute will extend past a partition into an adjacent chute to an extent where it will affect movement in the adjacent chute. If this were to occur, movement in one chute could be prevented due to product in the adjacent chute holding the roller from rotating. This problem is addressed by the roller module 600 not having any one roller in a chute extending both under and past the other side of a partition 80 to any significant extent.

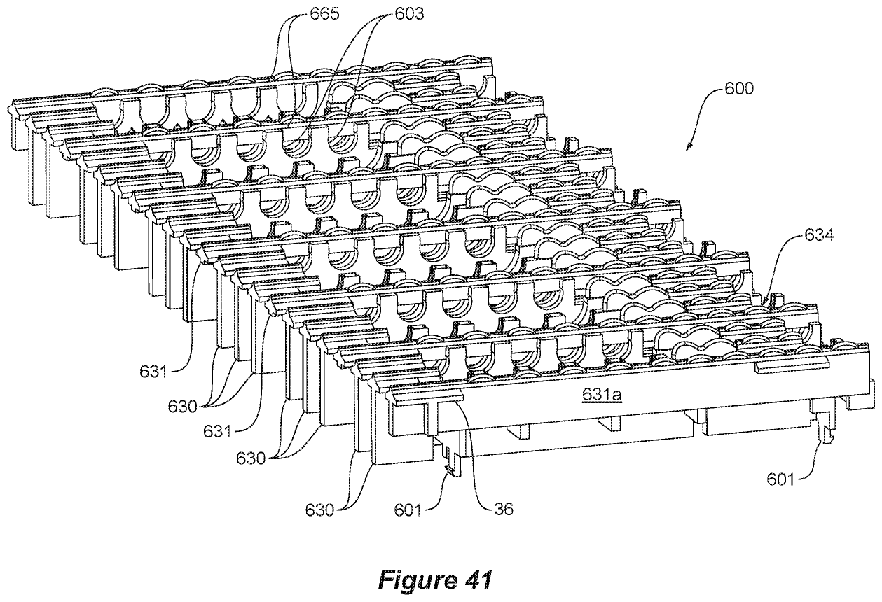

Referring to FIGS. 41 and 42, where there is shown a roller module 600 according to an embodiment, comprising an array of lengthwise extending slats 630 that extend from the front to the back of each module 600, and which are each spaced apart transversely across the width of the roller module 600.

In this embodiment, a number of roller modules 600 can extend across the full width of the underside of a single shelf module 500. A roller module 600 positions rollers 660 between adjacent pairs or groupings of slats.

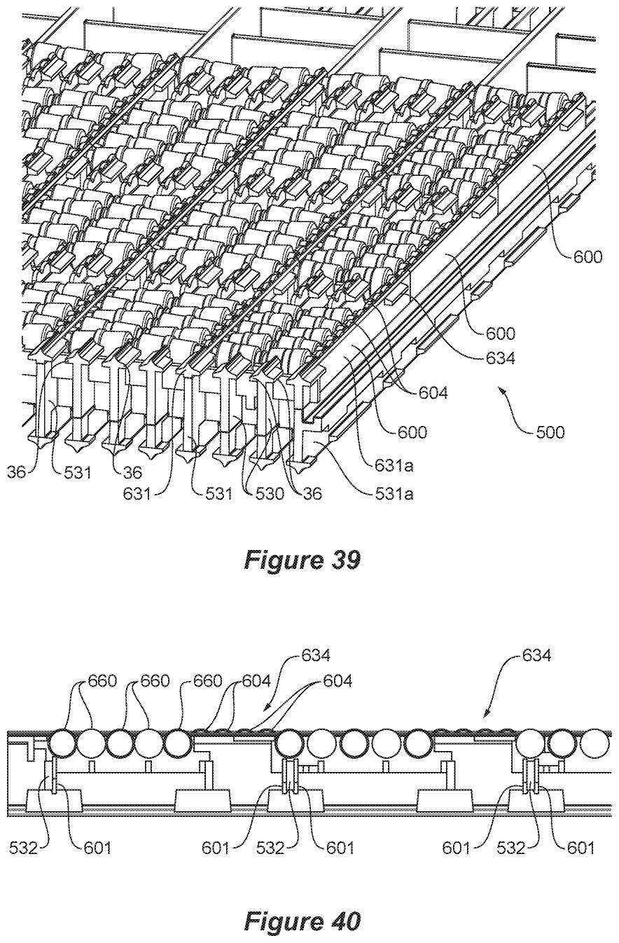

As best shown in FIGS. 39 and 41, at the front edge of a roller module 600, there are provided slats 630 and 631 having the same spacing as the slats 530 and 531 of the shelf module 500, such that when a roller module 600 engages with the shelf module 500, the slats 630 and 631 of the roller module 600 bear against the slats 530 and 531 of the shelf module 500. The flanges 36 of slats 630 and 631 only extend a short distance from the front edge of the roller module 600. It can also be seen that the roller module 600 features a cut out 602 to accommodate every fourth slat 531 of the shelf module 500 with slat 631 again having short lengths of flanges 36.

Towards the rear edge of the roller module 600 there is provided a region of a plurality of flange formations 634 for engagement with the feet of the previously described partitions 80. Between the flanges 36 of the front edge and the flange formations 634 on the roller module 600 there is provided a number of channels where a plurality of rollers 660 are located in each channel. The channels are defined by a pair of main walls 665 with a mid-wall 667 located between each pair of main walls 665. Each main wall 665 aligns with a slat 531 or the edge slat 531a. Each mid-wall 667 is positioned midway between each pair of main walls 665.

As will be seen in FIGS. 39 and 41, the two outer channels on the sides of the roller module 600 are narrower than the four channels between these two outer channels. The two outer channels span between four slats and there are two slats 630 between the slats 531. However, for the four channels between, each span between five slats and there are three slats 630 between the slats 531.

Each channel of the roller module 600 is configured to receive a plurality of transversely extending rollers 660 between each main wall 665 and the mid-wall 667. Each side of the main walls 665 are configured to provide a bearing support surface 603 for the outer ends 661 of each roller 660 with the inner section 662 of each roller 660 being supported by support surfaces 603 on the mid-walls 667.

In the case of the four inner channels, the rollers 660 each comprise a pair of rollers that are journaled to rotate independently of each other. In this way, an independently rotating roller is located between each of the slats. That is, there are five slats with four lines between each slat and so the plurality of rollers are lined up along these lines defined between the front adjacent slats. When a partition is located amongst the rollers 660, the partition will be located over the line of rollers below. The partition will substantially cover the roller with a very minimal part of each roller extending past each side of the partition.

In the case of the two outer channels, the rollers are shorter in length, but still comprise a pair of rollers that are journaled to rotate independently of each other. When the partition is located over the middle of the channel, the roller on either side of the partition will rotate independently of each other. When the partition is placed over the other two lines of rollers, it will substantially cover a roller, so that the roller will not extend past the edge to any extent that will affect the operation of the adjacent chute.

In order to locate partitions 80 as previously described in this specification, flange formations 634 are provided at spaced intervals to accommodate the feet spacing along the partition. This results in areas without rollers. In these regions, the crests of the slats are provided with a plurality of arcuate projections 604 having arcuate tops which are at the same height as the upper edge of each roller 660. The arcuate shape minimises contact area (reducing friction) with the product in the chute and provides a means of the product bridging the gaps between groups of rollers. The minimal width of the region without rollers and the provision of the arcuate projections 604 help movement of product over these regions.

Arcuate projections 604 are also provided along the length of each slat 631 and the end slats 631a of the roller modules 600. These slats 631 and 631 extend lengthwise along the depth of each roller module and so the arcuate projections assist in product movement when they are exposed within a product chute.

The rollers 660 have a main diameter of approximately 8 mm with bearings at each end that engage the support surfaces 603 having a diameter of approximately 4 mm. The support surfaces 603 may be arranged so that the bearings of the rollers 660 click into place to thereby retain them in place while still allowing smooth rotation.

Alternatively, a metal axle may be provided about which the rollers 660 rotate. Such an axle (not drawn) may be approximately 3 mm in diameter and may have a polished surface to minimise rotational friction. The support surfaces 603 may in this case be arranged to retentively accept the ends of such metal axles.

While in the embodiment shown and described, the roller module 600 is a separate component configured to removably attach to the shelf module 500, it will be appreciated that in an alternative embodiment the roller module and shelf module may form a unitary component, with the partition and roller engaging features of the roller module being present on the second major face of a shelf module.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A shelf assembly comprising a plurality of shelf modules joined together to provide a product support surface, wherein each shelf module comprises a pair of substantially parallel, lengthwise extending side edges comprising joining means cooperative with a joining element to join adjacent shelf modules along contiguous side edges thereof, and wherein each joining element is made from a material of higher specific strength than the shelf modules, such that the shelf assembly has sufficient strength and rigidity that it does not need to rest upon a conventional pre-provided shelf.

2. The shelf assembly as claimed in claim 1, wherein each joining element is elongate and of substantially the same length as the shelf module.

3. The shelf assembly in claim 1, wherein each joining element is an extruded metal, a plastic or a composite.

4. The shelf assembly as claimed in claim 1, wherein each joining means is in the form of a lengthwise extending channel adapted to receive the joining element.

5. The shelf assembly as claimed in claim 1, wherein each shelf module further comprises a plurality of lengthwise extending tubes spaced apart transversely across the shelf module, comprising a passageway for receiving a reinforcing element, wherein each reinforcing element is elongate and of substantially the same length as the shelf module.

6. The shelf assembly as claimed in claim 1, wherein each shelf module comprises a first major face and a second major face opposite the first, and wherein the first major face of each shelf module is adapted for engagement with at least one lengthwise extending partition, and the second major face is adapted to accommodate a plurality of transversely extending rollers.

7. The shelf assembly as claimed in claim 6, wherein the first major face is adapted for engagement with a plurality of transversely spaced, lengthwise extending partitions.

8. The shelf assembly as claimed in claim 6, wherein the shelf module comprises an array of lengthwise extending slats spaced apart transversely across the module, and an array of spaced apart, transversely extending ribs extending between these slats along the length of the module.

9. The shelf assembly as claimed in claim 8, wherein the slats sit proud of the ribs on the first major face.

10. The shelf assembly as claimed in claim 9, wherein the first major surface of the shelf module is adapted to engage the at least one partition by way of at least some of the slats comprising flange formations at or near an upper end thereof, each of the flange formations being separated from the flange formation on any adjacent slat.

11. The shelf assembly as claimed in claim 6, wherein the second major face is adapted to nest a plurality of transversely extending rollers arranged into a plurality of lengthwise extending rows.

12. The shelf assembly as claimed in claim 11, wherein the second major face of the shelf module is adapted to nest the plurality of rollers by way of comprising at least a pair of transversely spaced, lengthwise extending walls, between which the transversely extending rollers are nested.

13. The shelf assembly as claimed in claim 12, wherein the second major face of the shelf module comprises a plurality of the lengthwise extending walls transversely spaced across the shelf module so as to define a plurality of rows for the rollers.

14. The shelf assembly as claimed in claim 6, further comprising at least one partition, where each shelf module is positioned with its first major face upward, with the at least one partition secured thereto.

15. The shelf assembly as claimed in claim 6, further comprising a plurality of transversely extending rollers, where the shelf module is positioned with its second major face upward, with the rollers nested therein.

16. The shelf assembly of claim 6, wherein the second major face is further adapted for engagement with at least one lengthwise extending partition.

17. The shelf assembly as claimed in claim 16, wherein the second major face is further adapted for engagement with a plurality of transversely spaced, lengthwise extending partitions.

18. The shelf assembly as claimed in claim 16, further comprising at least one partition, and a plurality of transversely extending rollers, where each shelf module is positioned with its second major face upward, with the partition secured thereto and the rollers nested therein.

19. The shelf assembly as claimed in claim 6, further comprising a plurality of roller modules adapted for engagement with the second major face of each shelf module, each roller module adapted to nest a plurality of transversely extending rollers, and configured for engagement with at least one lengthwise extending portion.
